(19) United States
(12) Patent Application Publication
(10) Pub. No.: US 2006/0056613 A1
(43) Pub. Date: Mar. 16, 2006

(54) Mobile communication terminal with menu profiles

(75) Inventors: Chae-Kyung Kim, Seoul (KR); Myoung-Hee Jang, Gwangmyeong (KR)

Correspondence Address: LEE, HONG, DEGERMAN, KANG & SCHMADEKA;14th Floor, 801 S. Figueroa Street, Los Angeles, CA, 90017, US

(73) Assignee: LG Electronics Inc.

(21) Appl. No.: 11/193,261

(22) Filed: Jul. 29, 2005

(30) Foreign Application Priority Data
Jul. 30, 2004 (KR) 2004-60429

(51) Int. Cl. H04M 3/42; H04M 3/00

(52) U.S. Cl. 379/201.02; 379/418; 379/207.16

(57) ABSTRACT

The present invention relates to providing situation profiles of a mobile communication terminal by dividing modes of a profile menu according to peripheral conditions, presetting values to sub-menu functions suitable for the peripheral conditions of each mode, and selecting a specific mod when the mobile communication terminal is in a specific peripheral condition and simultaneously applying the sub-menu functions of the specific mode.

### CROSS-REFERENCE TO RELATED APPLICATIONS

Pursuant to 35 U.S.C. §119(a), this application claims the benefit of earlier filing date and right of priority to Korean Application No. 2004-60429, filed on Jul. 30, 2004, the contents of which is hereby incorporated by reference herein in its entirety.

### FIELD OF THE INVENTION

The present invention relates to a mobile communication terminal, and more particularly, to providing situation menu profiles in a mobile communication terminal.

### BACKGROUND OF THE INVENTION

A mobile communication terminal can support calling functions as well as additional functions, such as setting sound outputs for a ring type, a ring tone, a ringer volume, a message alert, a key volume related to sound, and the like. The additional functions are provided by sub-menus included in a sound menu of the mobile communication terminal. Accordingly, the user can activate the additional functions of the mobile communication terminal by setting a desired item or value in each sub-menu according to where the user with the mobile communication terminal is located (e.g. inside a car, outdoors, a quiet area, etc.).

FIGS. 1A to 1C are display views illustrating one example of a method for setting conditions of a mobile communication terminal in accordance with the related art. The method uses a menu related to sound outputs.

As shown in FIG. 1A, the user selects a menu button displayed on an initial image screen of a mobile communication terminal (hereinafter, referred to as a “terminal”), thereby displaying a main menu. If the user selects a volume/ringer menu related to sound outputs on the main menu, a plurality of sub-menus related to a ring type, a ring tone, a ringer volume, an earpiece volume, a message alert and a key volume, for example, are displayed as shown in FIG. 1B. In this state, if the user selects a specific sub-menu, for example, a ring type, more detailed (minute) sub-menus such as ring, vibrate, ring after vibrate and silent, for example, are displayed as shown in FIG. 1C. Accordingly, the user can select one of ring, vibrate, ring after vibrate, and silent for the ring type. In the same manner, the user can select one among the ring tone, ringer volume, earpiece volume, message alert, and key volume, and then set more detailed corresponding sub-menus.

However, because multiple sub-menus are included in each menu (e.g., volume/ringer menu), the user has to re-set the sub-menus in case the terminal moves to a different location or environment. For example, when the user with his terminal is located outdoors, the user can set the ring type as “ring after vibrate” and the ringer volume and earpiece volume can be set at a high level. Thereafter, if the user with his terminal moves indoors, the user may wish to set the ring type as “ring after vibrate” with the earpiece volume set at a low level. However, to do so, the user has to specifically set the corresponding values in each sub-menu, which is inconvenient and time consuming.

### SUMMARY OF THE INVENTION

The present invention is directed to setting functions of a mobile communication terminal according to peripheral conditions.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention is embodied in a method for setting functions of a mobile communication terminal according to peripheral conditions, the method comprising grouping a plurality of functions of the mobile communication terminal according to each of a plurality of profile modes, presetting values for each of the plurality of functions grouped in each profile mode, and selecting a specific profile mode according to the peripheral conditions and applying the plurality of functions grouped in the specific profile mode. Preferably, the plurality of profile modes are grouped according to the peripheral conditions of the mobile communication terminal.

In one aspect of the present invention, the plurality of functions comprise a function relevant to a sub-sound of the mobile communication terminal and a function for setting conditions. Preferably, the function relevant to a sub-sound of the mobile communication terminal comprises at least one of a ring type, a ring tone, a ringer volume, a message alert, and a key volume.

In another aspect of the invention, the plurality of profile modes comprises at least one of a vibrate only mode, a silent mode, a general mode, an outdoor mode, a car-kit mode, and a headset mode. Preferably, the plurality of profile modes are set and selected on sub-menus of a profile menu, wherein the profile menu is a located on a main menu.

In accordance with another embodiment of the present invention, a method for setting functions of a mobile communication terminal according to peripheral conditions comprises dividing modes of a profile menu according to the peripheral conditions, presetting values to sub-menu functions suitable for the peripheral conditions of each mode, and selecting a specific mode when the mobile communication terminal is in a specific peripheral condition and applying the sub-menu functions of the specific mode. Preferably, the profile menu is provided on a main menu.

In one aspect of the invention, the sub-menu functions comprise a function relevant to a sub-sound of the mobile communication terminal and a function for setting conditions. Preferably, the function relevant to a sub-sound of the mobile communication terminal comprises at least one of a ring type, a ring tone, a ringer volume, a message alert, and a key volume.

In another aspect of the invention, the modes comprise at least one of a vibrate only mode, a silent mode, a general mode, an outdoor mode, a car-kit mode, and a headset mode. Preferably, the sub-menu functions have values initially set according to each mode.

In accordance with another embodiment of the present invention, a method for setting functions of a mobile communication terminal according to peripheral conditions comprises providing a main menu having a profile menu, providing a plurality of profile modes respectively including at least one sub-menu function at the profile menu, selecting a specific profile mode, and simultaneously activating the at least one sub-menu function at the time of selecting the specific profile mode.

In one aspect of the invention, the at least one sub-menu function comprises at least one of a function relevant to a sub-sound of the mobile communication terminal and a function for setting conditions. Preferably, the function relevant to a sub-sound of the mobile communication terminal comprises at least one of a ring type, a ring tone, a ringer volume, a message alert, and a key volume.

In another aspect of the invention, the plurality of profile modes comprises at least one of a vibrate only mode, a silent mode, a general mode, a car-kit mode, and a headset mode.

In accordance with another embodiment of the present invention a mobile terminal for setting functions of according to peripheral conditions comprises an input unit to receive inputs from a user, an output unit to provide outputs to the user, a graphics processor to generate graphical information on the display, and a microprocessor operatively connected with the input unit, the output unit, and the graphics processor. The microprocessor is for providing situation profiles related to physical locations and situations that the user experiences and providing functions of the mobile terminal associated thereto, allowing the user to correlate the provided situation profiles with the provided functions to configure one or more situation menu profiles, and allowing the user to select from the configured situation menu profiles to activate the provided functions without requiring the user to select the provided functions.

Preferably, the configured situation menu profiles are provided in a graphical menu format on a display of the output unit.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIGS. 1A to 1C are display views illustrating a method for setting conditions of a mobile communication terminal in accordance with the related art.

FIG. 2 is a flow chart illustrating a method for setting conditions of a mobile communication terminal in accordance with one embodiment of the present invention.

FIGS. 3A to 3C and FIGS. 4A and 4B are display views illustrating a method for setting conditions of a mobile communication terminal in accordance with one embodiment of the present invention.

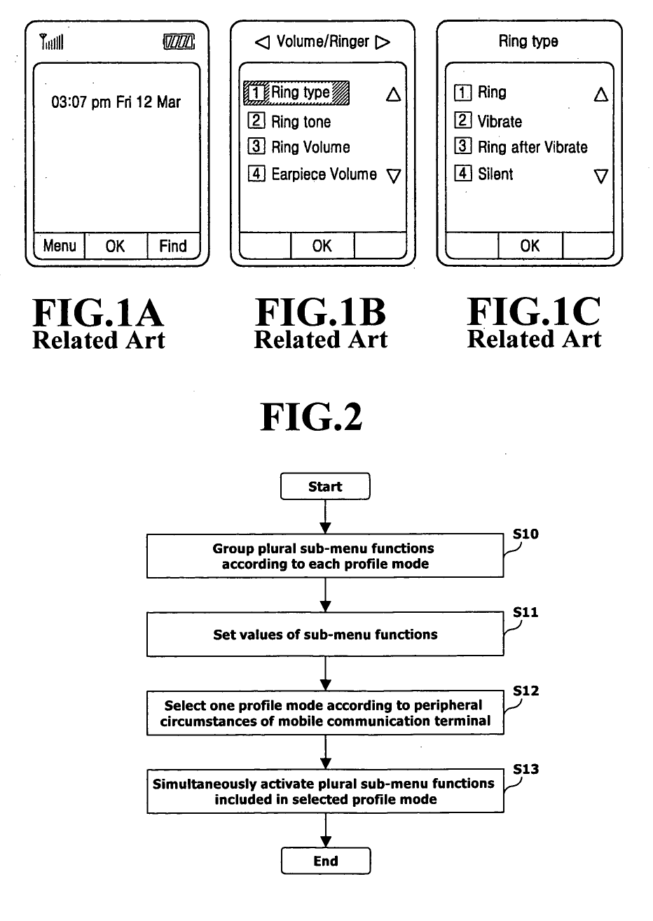

### DETAILED DESCRIPTION OF THE PREFERRED EMBODIMENTS

The present invention relates to providing situation menu profiles in a mobile communication terminal.

Reference will now be made in detail to the preferred embodiments of the present invention, examples of which are illustrated in the accompanying drawings.

The present invention relates to a method for directly applying sub-menu functions corresponding to specific conditions according to where a mobile communication terminal is located. Such locations may be inside a car, outdoors or a quiet area, for example. According to the present invention, a user does not have to additionally re-set values of sub-menus. This is achieved by dividing situation (condition) profile modes according to peripheral conditions and presetting the values of sub-menus suitable for the conditions to each mode.

The present invention relates to a profile menu comprising a plurality of profile modes in a main menu of a mobile communication terminal. Each profile mode includes a plurality of sub-menus for setting additional functions (e.g., sub-menu functions) such as a ring type, a ring tone, a ringer volume, a message alert, a key volume, etc. Accordingly, the user can set values of the sub-menus included in each profile mode, and then select one of the plural profile modes according to condition changes of the mobile communication terminal. Thus, functions of the sub-menus included in the corresponding profile mode are simultaneously applied to the mobile communication terminal.

Specifically, in the present invention, several modes are set into a profile menu, and each mode is provided with integrated functions such as adjusting a ring type, a ring tone, a ringer volume, a message alert, a key volume, etc. Accordingly, if sub-menu functions for each mode are initially set only one time, the user can later select a corresponding mode when necessary to select a function relevant to the desired sound output.

Hereinafter, a method for setting circumstances of a mobile communication terminal will be explained with reference to the attached drawings. FIG. 2 is a flowchart illustrating a method for setting conditions of a mobile communication terminal in accordance with one embodiment of the present invention.

Referring to FIG. 2, a user may be provided with a profile menu in a main menu to initially allow the user to group together various functions of a plurality of sub-menus (additional functions) according to each profile mode (S10). When each profile mode is divided, the user pre-sets values of the sub-menus suitable for peripheral conditions to each profile mode (S11). If the user selects one specific profile mode when the mobile communication terminal is in a specific peripheral condition, all functions of the sub-menus of the corresponding profile mode are simultaneously applied to the mobile communication terminal (S12, S13).

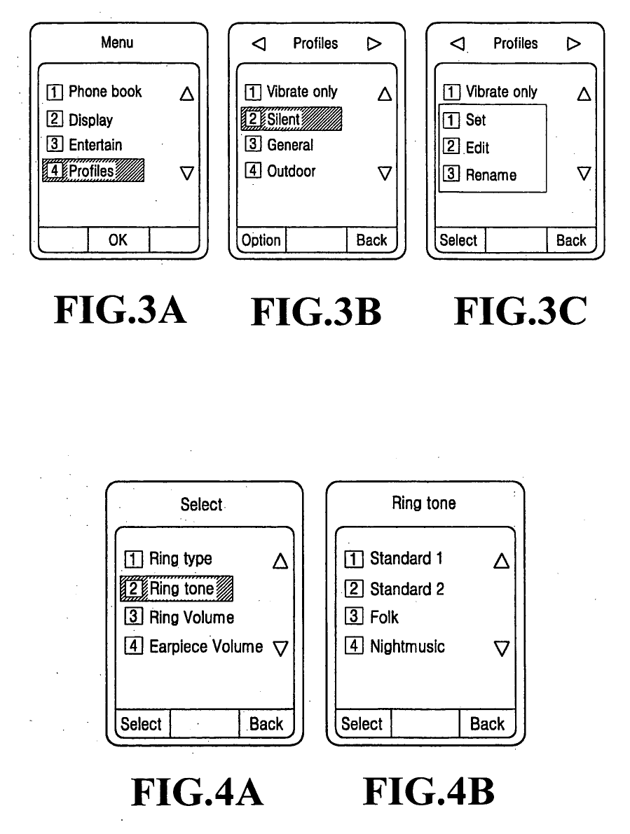

FIGS. 3A to 3C are display views illustrating a method for setting conditions of a mobile communication terminal in accordance with one embodiment of the present invention.

Referring to FIG. 3A, the present invention provides “profiles” in a main menu of the mobile communication terminal or any other type of wireless communication device. Here, a “profile” refers to user preferences that specify how the terminal should operate according to particular conditions. For example, ring tones or other audible sound outputs may be undesirable for certain situations or locations (e.g., during a business meeting). Therefore, the user may wish to turn the mobile terminal into an “etiquette” mode or a “vibrate” mode, whereby the user is notified of incoming calls or data through vibrations generated by the mobile terminal. In other situations, the user may not wish to be disturbed by such vibrations (e.g., in a movie theater). Accordingly, the user may wish to select a “silent” mode, whereby no indications, such as audible ring tones and sounds or physical indications like vibrations, are generated by the mobile terminal.

Furthermore, certain situations may require the mobile terminal to provide a stronger indication or output to the user due to surrounding noise. Thus, the ringer volume should be increased to a maximum level in order for the user to realize that an incoming call is being received. Other situations, such as when a “hands-free” function of the mobile terminal is activated during driving, can also be accommodated for by providing the situation profiles of the present invention. Preferably, the situation profiles are pre-selected by the user via a profile menu.

Referring FIG. 3B, the profile menu may provide the options of a vibrate only mode, a silent mode, a general mode, an outdoor mode, a car-kit mode, a headset mode, and the like. The vibrate only mode denotes peripheral conditions where a vibration is allowable. The silent mode denotes peripheral conditions where not even the smallest sounds should be heard. The general mode denotes ordinary peripheral conditions where a mobile communication terminal is located. The outdoor mode denotes outdoor conditions. The car-kit mode denotes being inside a car or other automobile. The headset mode denotes conditions where calling is performed with the use of a headset.

In a preferred embodiment of the present invention, the above six profile modes are shown merely for the sake of explanation. It is contemplated that other profile modes may be included and different profile modes may be used.

Each profile mode may include one or more functions relevant to sub-sounds (i.e., various types of sounds and audible outputs) and one or more functions for setting the conditions (situations) of the mobile communication terminal. For example, each profile mode can include sub-functions, such as selecting and adjusting a ring type, a ring tone, a ringer volume, an ear-piece volume, a message alert, a key volume, etc. Accordingly, the mobile communication terminal may include each sub-menu function set according to each profile mode, and the user may set each sub-menu function, as necessary.

For example, when the user selects a silent mode on the profile menu shown in FIG. 3B, a small pop-up window is displayed as shown in FIG. 3C. In the pop-up window, “set,” “edit,” and “rename” menus may be provided. The set menu is used for setting sub-menus included in the silent mode. The edit menu is used for editing the sub-menus included in the silent mode. The rename menu is used for changing the silent mode into another profile mode having a different name. The user may change the name of the profile mode into another name by using the rename menu.

If the user selects the edit menu, sub-menus included in the silent mode, such as ring type, ring tone, ringer volume, message alert, key volume, and the like may be displayed as shown in FIG. 4A. Preferably, other profile modes may include the same sub-menus as those of the silent mode, as well as additional or different sub-menus. Accordingly, when the user selects a ring tone among the sub-menus of the silent mode, lower level (i.e., more detailed) sub-menus may be displayed as shown in FIG. 4B. The user may then select the desired ring sound among the lower level sub-menus and thereby set a value to the selected sub-menu.

In FIGS. 3A to 3C and FIGS. 4A and 4B, values of the sub-menus included in the silent mode among the plurality of profile modes were explained. However, the same process can set values of the sub-menus included in each of the plurality of profile modes.

For example, in the outdoor mode, the ring type may be set as ring after vibrate, the ring tone may be set as night music, the ringer volume may be set as high, the message alert may be set as sound, and the key volume may be set at the highest level by considering outdoor conditions.

In a state where the values are set to sub-menus included in each profile mode, when the mobile communication terminal encounters a new peripheral condition such as when the user with his mobile terminal moves into another type of location, the user may select a profile mode corresponding to the new peripheral condition provided on the display of the mobile terminal. Thus, the functions of the sub-menus included in the selected profile mode are simultaneously applied to the mobile communication terminal. Accordingly, the functions of the sub-menus are easily applied to the mobile terminal when the user simply stores each profile mode.

The present invention improves user-friendliness of a wireless communication device by allowing the user to pre-set various types of functions in the device according to different types of situations and physical locations the user may be in. By providing the user with situation profiles that are linked with various functions of the device that would be appropriate for that particular situation, the user may simply select his desired situation profile, and the device will activate the various functions associated thereto. For example, as the present invention provides the user with selectable situation profiles that have related functions previously selected by the user, the user may simply refer to those profiles and select the desired one. Accordingly, the device (handset) will activate the appropriate functions associated thereto, instead of the user having to scroll through various different menus each time the user wishes to set different functions of the device based on the situation or location.

As aforementioned, in the present invention, the profile menu is provided with several modes corresponding to variable conditions, and each mode is provided with at least one sub function, such as a function relevant to sound, for example. Accordingly, the sub functions may be selected according to each condition.

Additionally, in the present invention, the profile menu is provided with different modes divided according to peripheral conditions such as inside of a car, outdoors, a calm place, etc. Each menu is provided with values of sub-menus suitable for the peripheral conditions. Accordingly, when the mobile communication terminal is in a specific peripheral condition, a proper mode is selected and functions of the sub-menus of the selected mode are simultaneously applied to the mobile communication terminal without additionally re-setting the sub-menu functions.

As can be understood, the implementation of the present invention may be achieved by software, hardware, and/or any combination thereof. For example, a mobile terminal device (or other type of wireless communications apparatus) according to the present invention includes an input unit (e.g., keypad, hardware function buttons, graphical function buttons, microphone, etc.) to receive inputs from a user; an output unit (e.g., display, screen, audio speaker, etc.) to provide outputs to the user; a graphics processor to generate graphical information on the display; and a microprocessor cooperating with the input unit, the output unit, and the graphics processor for, providing the user with situation profiles related to physical locations and situations that the user may experience and providing functions of the mobile terminal device associated thereto, allowing the user to initially correlate the provided situation profiles with the provided functions to configure one or more situation menu profiles, and allowing the user to subsequently select from the configured situation menu profiles which selection then activates the associated functions without requiring user selection of those functions. Here, the configured situation menu profiles can be provided in a graphical menu format on a display of the output unit.

As the present invention may be embodied in several forms without departing from the spirit or essential characteristics thereof, it should also be understood that the above-described embodiments are not limited by any details of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for setting functions of a mobile communication terminal according to peripheral conditions, the method comprising:
grouping a plurality of functions of the mobile communication terminal according to each of a plurality of profile modes;
presetting values for each of the plurality of functions grouped in each profile mode; and
selecting a specific profile mode according to the peripheral conditions and applying the plurality of functions grouped in the specific profile mode.

2. The method of claim 1, wherein the plurality of profile modes are grouped according to the peripheral conditions of the mobile communication terminal.

3. The method of claim 1, wherein the plurality of functions comprise:
a function relevant to a sub-sound of the mobile communication terminal; and
a function for setting conditions.

4. The method of claim 3, wherein the function relevant to a sub-sound of the mobile communication terminal comprises at least one of:
a ring type;
a ring tone;
a ringer volume;
a message alert; and
a key volume.

5. The method of claim 1, wherein the plurality of profile modes comprises at least one of:
a vibrate only mode;
a silent mode;
a general mode;
an outdoor mode;
a car-kit mode; and
a headset mode.

6. The method of claim 5, wherein the plurality of profile modes are set and selected on sub-menus of a profile menu.

7. The method of claim 6, wherein the profile menu is a located on a main menu.

8. A method for setting functions of a mobile communication terminal according to peripheral conditions, the method comprising:
dividing modes of a profile menu according to the peripheral conditions;
presetting values to sub-menu functions suitable for the peripheral conditions of each mode; and
selecting a specific mode when the mobile communication terminal is in a specific peripheral condition and applying the sub-menu functions of the specific mode.

9. The method of claim 8, wherein the profile menu is provided on a main menu.

10. The method of claim 8, wherein the sub-menu functions comprise:
a function relevant to a sub-sound of the mobile communication terminal; and
a function for setting conditions.

11. The method of claim 1 0, wherein the function relevant to a sub-sound of the mobile communication terminal comprises at least one of:
a ring type;
a ring tone;
a ringer volume;
a message alert; and
a key volume.

12. The method of claim 8, wherein the modes comprise at least one of:
a vibrate only mode;
a silent mode;
a general mode;
an outdoor mode;
a car-kit mode; and
a headset mode.

13. The method of claim 8, wherein the sub-menu functions have values initially set according to each mode.

14. A method for setting functions of a mobile communication terminal according to peripheral conditions, the method comprising:
providing a main menu having a profile menu;
providing a plurality of profile modes respectively including at least one sub-menu function at the profile menu;
selecting a specific profile mode; and
simultaneously activating the at least one sub-menu function at the time of selecting the specific profile mode.

15. The method of claim 14, wherein the at least one sub-menu function comprises at least one of:
a function relevant to a sub-sound of the mobile communication terminal; and
a function for setting conditions.

16. The method of claim 15, wherein the function relevant to a sub-sound of the mobile communication terminal comprises at least one of:
a ring type;
a ring tone;
a ringer volume;
a message alert; and
a key volume.

17. The method of claim 14, wherein the plurality of profile modes comprises at least one of:
a vibrate only mode;
a silent mode;
a general mode;
a car-kit mode; and
a headset mode.

18. A mobile terminal for setting functions of according to peripheral conditions, the mobile terminal comprising:
an input unit to receive inputs from a user;
an output unit to provide outputs to the user;
a graphics processor to generate graphical information on the display; and
a microprocessor operatively connected with the input unit, the output unit, and the graphics processor for providing situation profiles related to physical locations and situations that the user experiences and providing functions of the mobile terminal associated thereto and allowing the user to correlate the provided situation profiles with the provided functions to configure one or more situation menu profiles and allowing the user to select from the configured situation menu profiles to activate the provided functions without requiring the user to select the provided functions.

19. The mobile terminal of claim 18, wherein the configured situation menu profiles are provided in a graphical menu format on a display of the output unit.
